(19) United States
(12) Patent Application Publication
(10) Pub. No.: US 2005/0207170 A1
(43) Pub. Date: Sep. 22, 2005

(54) Clip-on portable lamp

(75) Inventor: Rainer Opolka, Solingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ZWEIBRUDER OPTOELECTRONICS GMBH

(21) Appl. No.: 11/082,770

(22) Filed: Mar. 16, 2005

(30) Foreign Application Priority Data
Mar. 17, 2004 (DE) 202004004276.2

(51) Int. Cl. F21V 21/00; F21V 21/36; F21V 21/08

(52) U.S. Cl. 362/391; 362/157

(57) ABSTRACT

A lamp has a flexible stem having an inner end and an outer end, a light source on the outer end, a clip on the inner end provided with a jack, and a power-supply cable removably pluggable into the jack. This clip can be secured to a suitable support, such as a book cover or laptop lid, or even on a jacket lapel, belt, or bill of a cap. Once the clip is mounted in place, the flexible stem is deformed to direct the light emitted by the source, e.g. an LED, on the desired location. The jack allows the lamp to be connected to a transformer, a battery, or any suitable low-voltage power source.

### FIELD OF THE INVENTION

The present invention relates to a clip-on portable lamp. More particularly this invention concerns such a lamp usable in conjunction with a computer.

### BACKGROUND OF THE INVENTION

A clip-on lamp is used when light needs to be shed on a limited area. For instance such a lamp can be attached to a book or a laptop computer. It can be battery powered or can connect to an external power source, such as the standard line, a motor-vehicle low-voltage socket, or even the power source of a computer.

German 203 10 780 describes such a lamp having a stiff but flexible stem with an outer end carrying a light source, e.g. an incandescent bulb, a fluorescent bulb, or a light-emitting diode (LED), and an inner end to which is fixed a battery case having a clip. The clip is suited for holding the lamp on the lid of a laptop so that a user can illuminate its keyboard.

### OBJECTS OF THE INVENTION

It is therefore an object of the present invention to provide an improved clip-on portable lamp.

Another object is the provision of such an improved clip-on portable lamp that overcomes the above-given disadvantages, in particular that can be used in many different applications.

### SUMMARY OF THE INVENTION

A lamp has according to the invention a flexible stem having an inner end and an outer end, a light source on the outer end, a clip on the inner end provided with a jack, and a power-supply cable removably pluggable into the jack. This clip can be secured to a suitable support, such as a book cover or laptop lid, or even on a jacket lapel, belt, or bill of a cap. Once the clip is mounted in place, the flexible stem is deformed to direct the light emitted by the source, e.g. an LED, on the desired location. The jack allows the lamp to be connected to a transformer, a battery, or any suitable low-voltage power source.

The lamp further has according to the invention a battery case connected to the power-supply cable. The battery case can be provided with another jack into which the power-supply cable can be plugged. The battery case holds batteries which can be recharged when the case is provided with a USB jack by means of which the batteries in the case can be recharged.

To further ease use of the lamp, the battery case is provided with a clip for securing it to a support.

The power-supply cable according to the invention can have a plug adapted to fit in a vehicle accessory outlet, or of course it can have a transformer that plugs into a standard line-voltage outlet.

### BRIEF DESCRIPTION OF THE DRAWING

The above and other objects, features, and advantages will become more readily apparent from the following description, reference being made to the accompanying drawing in which:

FIG. 1 is a perspective view of a lamp according to the invention;

FIG. 2 is a perspective view of a battery case for such a lamp; and

FIG. 3 is a perspective view of a cable end for the lamp.

### SPECIFIC DESCRIPTION

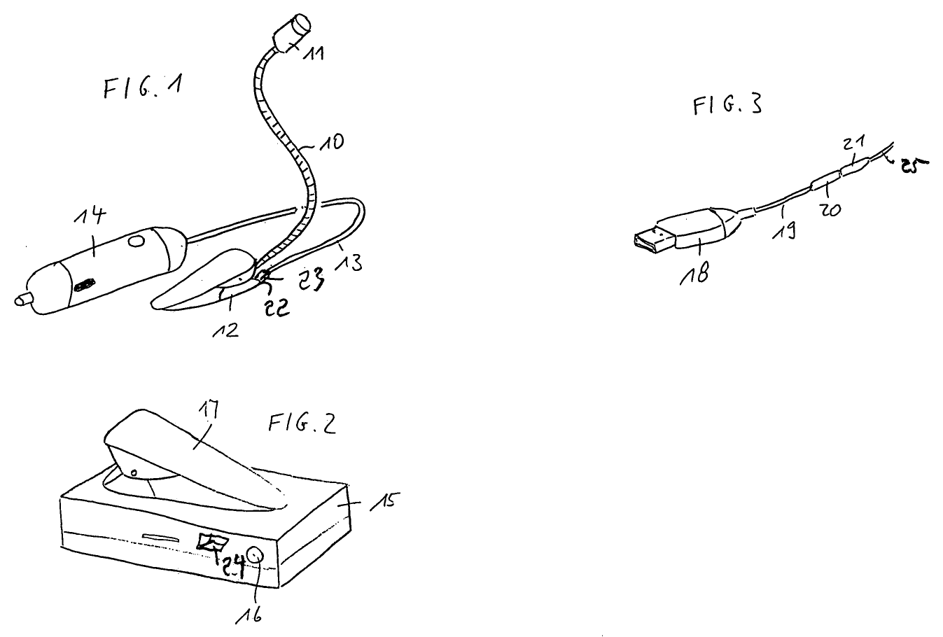

As seen in FIG. 1 a lamp has a flexible but stiff stem 10 whose outer end has a head 11 including a light source, here an LED, and an inner end fitted to a clip 12. A socket 22 in the clip 12 receives a plug 23 at one end of a supply cable 13 whose other end has a plug 14 adapted to fit in a motor-vehicle accessory or cigarette-lighter jack.

FIG. 2 shows a battery case 15 adapted to hold rechargeable batteries and provided with a clip 17 so it can be secured to a support when in use. A patch cord 25 (FIG. 3) has a plug 21 that can be fitted into a jack 16 on the case 15 and into the socket 22 on the clip 12 to power the lamp. In addition a USB jack 24 on the case 15 can be connected via a standard USB cable to a computer to recharge the batteries in the case 15 or operate the lamp off the computer when the batteries are dead.

FIG. 3 shows another patch cable 19 with a USB plug 18 on one end and a socket 20 on the other that can fit with the plug 21 on the end of the patch cord 25 for powering the lamp directly from a laptop's USB port. The plug 21 at the end of the patch cable 25 and elsewhere can be standard miniplugs, BNC connectors, or any other off-the-shelf plug capable of transmitting the necessary current safely.

1. A lamp comprising:
a flexible stem having an inner end and an outer end;
a light source on the outer end;
a clip on the inner end provided with a jack; and
a power-supply cable removably pluggable into the jack.

2. The lamp-defined in claim 1, further comprising
a battery case connected to the power-supply cable.

3. The lamp defined in claim 2 wherein the battery case is provided with another jack into which the power-supply cable can be plugged.

4. The lamp defined in claim 2 wherein the battery case has a USB jack by means of which batteries in the case can be recharged.

5. The lamp defined in claim 2 wherein the battery case is provided with a clip for securing it to a support.

6. The lamp defined in claim 3 wherein the power-supply cable has a plug adapted to fit in a vehicle accessory outlet.
